(19) United States
(12) Patent Application Publication
(10) Pub. No.: US 2025/0378129 A1
(43) Pub. Date: Dec. 11, 2025

(54) RECOGNITION AND PROCESSING OF ARITHMETIC HANDWRITING STROKES

(71) Applicant: Apple Inc., Cupertino, CA (US)

(72) Inventors: Ryan S. DIXON, Redwood City, CA (US); Aditya GALADA, Santa Clara, CA (US); Francisco ALVARO MUNOZ, Zurich (CH); Martin BRESLER, Santa Clara, CA (US); Peder BLEKKEN, Morgan Hill, CA (US); Thomas DESELAERS, Zurich (CH)

(21) Appl. No.: 19/064,592

(22) Filed: Feb. 26, 2025

Related U.S. Application Data
(60) Provisional application No. 63/657,957, filed on Jun. 9, 2024.
(60) Provisional application No. 63/658,407, filed on Jun. 10, 2024.

(51) Int. Cl. G06F 17/11; G06F 3/04883; G06T 11/20

(52) U.S. Cl. CPC G06F 17/11; G06F 3/04883; G06T 11/206; G06T 2200/24

(57) ABSTRACT

Systems for electronic devices evaluate handwriting strokes, provided by a user to an electronic device, for math strokes and determine a result of the math strokes. The math strokes represent a mathematical expression and the result represents a solution to the mathematical expression. The result may be updated based on an update to the math strokes.

### CROSS REFERENCE TO RELATED APPLICATION(S)

The present application claims the benefit of U.S. Provisional Application No. 63/658,407, entitled “RECOGNITION AND PROCESSING OF ARITHMETIC HANDWRITING STROKES”, filed Jun. 10, 2024, and of U.S. Provisional Application No. 63/657,957, entitled “RECOGNITION AND PROCESSING OF ARITHMETIC HANDWRITING STROKES”, filed Jun. 9, 2024, the entirety of which is incorporated herein for reference.

### TECHNICAL FIELD

This application is directed to identifying user-provided strokes (e.g., user handwriting), and in particular, identifying which user-provided handwriting strokes are associated with a mathematical (arithmetic) expression and providing the arithmetic strokes, corresponding to the mathematical expression, to a calculator to solve the mathematical expression.

### BACKGROUND

Users may input a mathematical expression (e.g., equation) into a computing system, such as via a calculator application or a web browser running on the computing system. The computing system evaluates the mathematical expression and provides a solution to the mathematical expression.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a plan view of an embodiment of an electronic device, in accordance with one or more aspects of the present disclosure.

FIG. 2 illustrates a block diagram of an example of an electronic device that may be used to for recognition and processing of arithmetic handwriting strokes, in accordance with one or more aspects of the present disclosure.

FIG. 3A illustrates a plan view of the electronic device, further showing various handwriting strokes presented on a display, in accordance with one or more aspects of the present disclosure.

FIG. 3B illustrates a plan view of the electronic device, further showing a display presenting a result (e.g., solution) for handwritten strokes identified as arithmetic or math strokes, in accordance with one or more aspects of the present disclosure.

FIG. 3C illustrates a plan view of the electronic device, further showing the display presenting updated results based on a change to handwritten strokes identified as math strokes, in accordance with one or more aspects of the present disclosure.

FIG. 4 illustrates an example of a process flow for solving a handwriting mathematical expression, in accordance with one or more implementations.

FIG. 5, FIG. 6, and FIG. 7 illustrate flow diagrams showing examples of processes that may be performed for determining a result to a mathematical expression generated by handwritten strokes, in accordance with one or more aspects of the present disclosure.

FIG. 8A illustrates an electronic system with which one or more implementations of the subject technology may be implemented.

FIG. 8B, FIG. 8C, FIG. 8D, FIG. 8E, FIG. 8F, and FIG. 8G illustrate processes executable by electronic devices or block diagrams of electronic devices with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to a system (or systems) for evaluating user handwritten strokes (e.g., handwriting) provided to a document presented on a display of electronic device and determining whether the user handwriting strokes are recognized as arithmetic strokes. As used in the detailed description, “math strokes” may refer to mathematical and/or arithmetic-based handwriting, such as number, variables, operands, operators, symbols, or the like. In the event math strokes are recognized in the handwriting strokes, the math strokes are grouped together and tagged as arithmetic and/or mathematical data, which can be used to determine one or more mathematical expressions from the math strokes. The mathematical expression(s) are subsequently calculated/solved and the display is updated with a result (e.g., solution) to each determined mathematical expression.

Further, in the event a mathematical expression is updated by a user, the system is designed to update, in real time or near real time, other mathematical expressions based on the user-updated mathematical expression. For example, a first mathematical expression states “a=2”, a second method mathematical expression states “b=3”, and a third mathematical expression states “a+b=”, the system can evaluate the third mathematical expression, determine the result is 5 (five), by initially evaluating the first and second mathematical expression. The system can update the display to provide “5” proximate to the equal sign. However, if the user updates the first mathematical expression to state “a=4”, then the system may, in real time, recognize the update to the first mathematical expression, and re-evaluate the third mathematical expression to determine that the updated result is 7 (seven). The system can update the display to provide “7” proximate to the equal sign. By recognizing strokes as math strokes, the system can identify individual variables, operands, and operators and allow for real time manipulation of those objects and real time updates of the result.

Systems described herein may include a model (e.g., machine learning (ML) model, large language model (LLM), etc.) that is trained to identify math strokes. In this regard, at least some models described herein may be trained to distinguish math strokes from other handwriting strokes, such as text strokes and non-text (e.g., drawing) strokes. By recognizing handwriting strokes as math strokes, generating intermediate data based on the handwriting strokes, and sending the intermediate data to a process for performing mathematical calculations, processing can be faster, as opposed to sending an image frame of the document to a process that has to perform both character recognition and mathematical calculations in real time.

Additionally, by recognizing the handwriting strokes as math strokes, the system can identify the location within the document to display the result. For example, a horizontally oriented mathematical expression, the result may be displayed proximate to (e.g., to the right of) an equal (“=”) operator, or equal sign. Conversely, for a vertically oriented mathematical expression, the result may be located below a horizontal line. Moreover, systems described herein may be trained on training data with both horizontally oriented and vertically oriented mathematical expressions, and determine whether math strokes are horizontally oriented or vertically oriented mathematical expressions.

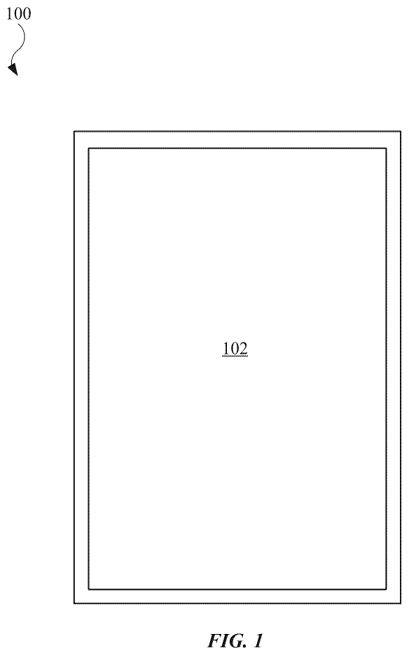

These and other embodiments are discussed below with reference to FIGS. 1-11. However, those skilled in the art will readily appreciate that the detailed description given herein with respect to these Figures is for explanatory purposes only and should not be construed as limiting.

FIG. 1 illustrates a plan view of an embodiment of an electronic device 100, in accordance with one or more aspects of the present disclosure. As non-limiting examples, the electronic device 100 may take the form of a mobile wireless communication device (e.g., smartphone, tablet computing device). The electronic device 100 may include a display 102 designed to present visual information in the form of still images such as text information (e.g., words, letters, numbers) and non-text information (e.g., drawings). Additionally, or in combination, the display 102 may present visual information in the form of motion images such as video. In one or more implementations, the display 102 takes the form of capacitive input display designed to receive inputs in the form of touch inputs (e.g., from a user's digit(s)) or from a digital stylus). In this regard, the display 102 may be updated to present the received inputs. In one or more implementations, user input, e.g., handwriting input may be provided by tracking the movement of a user's finger or other body part.

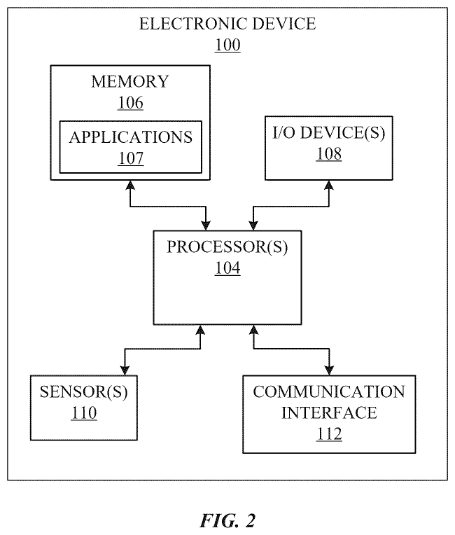

FIG. 2 illustrates a block diagram of an example of an electronic device that may be used to for recognition and processing of arithmetic handwriting strokes, in accordance with one or more aspects of the present disclosure. The electronic device 100 shown in FIG. 2 may be implemented in any other electronic device for use with the subject technology. Variations in the arrangement and type of the components may be made without departing from the spirit or scope of the claims as set forth herein. Additional components, different components, or fewer components may be provided.

The electronic device 100 may include one or more processors 104, a memory 106, one or more input-output devices 108 (I/O devices(s)), one or more sensors 110, and a communication interface 112. The one or more processors 104 may include a central processing unit, a graphics processing unit, one or more microcontrollers, or a combination thereof. Further, the one or more processors 104 may include suitable logic, circuitry, and/or code that enable processing data and/or controlling operations of the electronic device 100. In this regard, the one or more processors 104 may be enabled to provide control signals to various other components of the electronic device 100. The one or more processors 104 may also control transfers of data between various portions of the electronic device 100. The one or more processors 104 may further implement an operating system or may otherwise execute code to manage operations of the electronic device 100.

The memory 106 may include suitable logic, circuitry, and/or code that enable storage of various types of information such as received data, generated data, code, and/or configuration information. The memory 106 may include volatile memory (e.g., random access memory (RAM)) and/or non-volatile memory (e.g., read-only memory (ROM), flash, and/or magnetic storage). In one or more implementations, the memory 106 may store user account data, and any other data generated in the course of performing the processes described herein. Additionally, the memory 106 stores applications 107. As non-limiting examples, the applications 107 may include models (e.g., ML models), application program interface (APIs), software developer kits (SDKs), drawing/writing applications, calculator applications.

The one or more input-output devices 108 may include a display. In one or more implementations, the display includes a capacitive touch input display, thus allowing the user to interact with the electronic device 100 by a touch input or gesture to the display. Additionally, the one or more input-output devices 108 may include one or more buttons, which may be actuated by a user of the electronic device 100. The one or more input-output devices 108, while taking the form of a display and/or buttons, may be used to provide an input to the one or more processors 104 in order to, for example, initiate a payment through a payment provider. Further, the one or more input-output devices 108 may include an audio module (e.g., speaker) designed to convert electrical signals into soundwaves in the form of audible sound.

The one or more sensors 110 may include one or more microphones, speakers and/or cameras. Accordingly, the one or more sensors 110 may include transducers designed to convert audible sound to electrical signals, or vice versa. Also, the one or more sensors 110 may captures images of the ambient environment.

The communication interface 112 may include suitable logic, circuitry, and/or code that enables wired or wireless communication, such as between the electronic device 100 and a network (not shown in FIG. 2). The communication interface 112 may include, for example, one or more of a BLUETOOTH® communication interface, an NFC interface, a Zigbee communication interface, a WLAN communication interface, a Universal Serial Bus (USB) communication interface, a cellular interface, or generally any communication interface. Accordingly, the communication interface 112 may establish a radio network, allowing the electronic device 100 to communicate with another device.

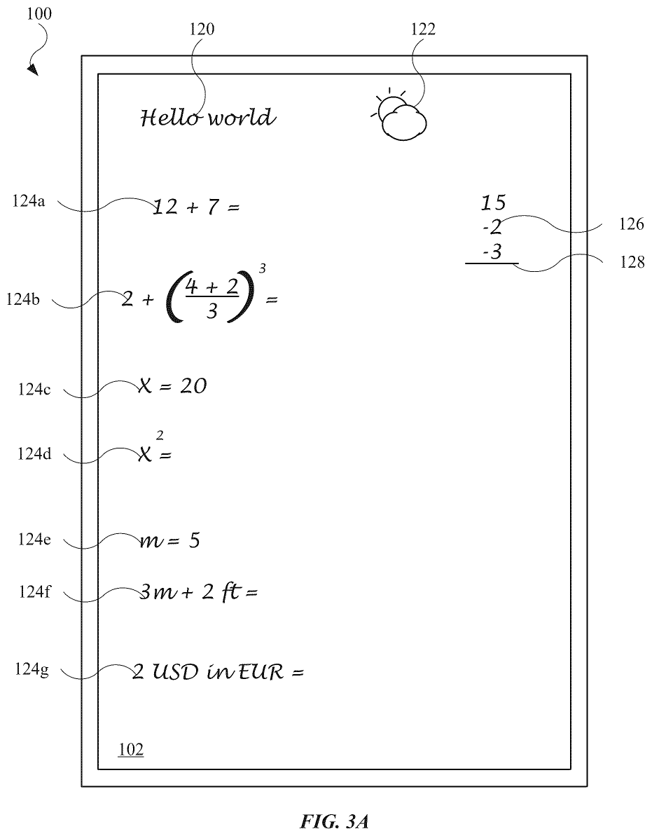

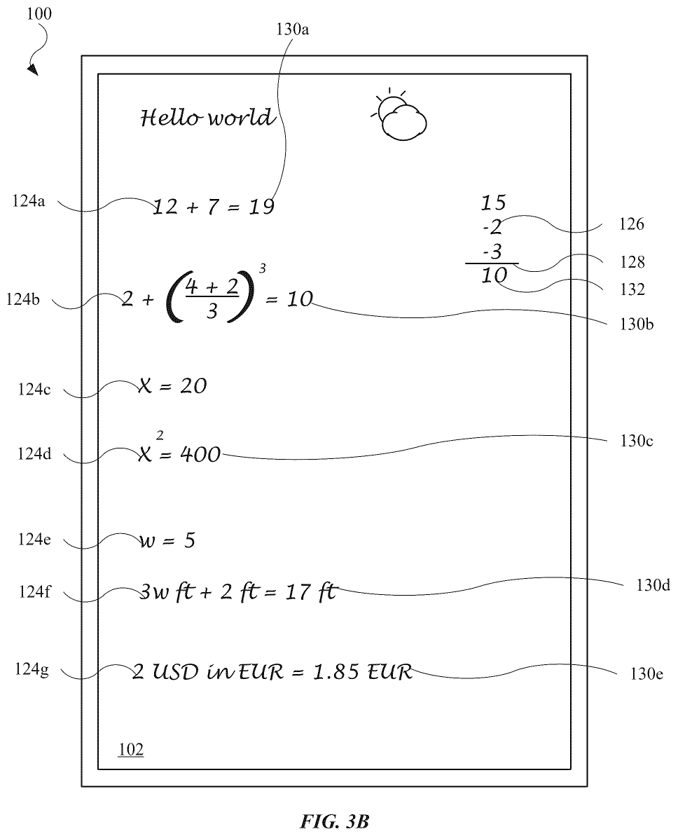

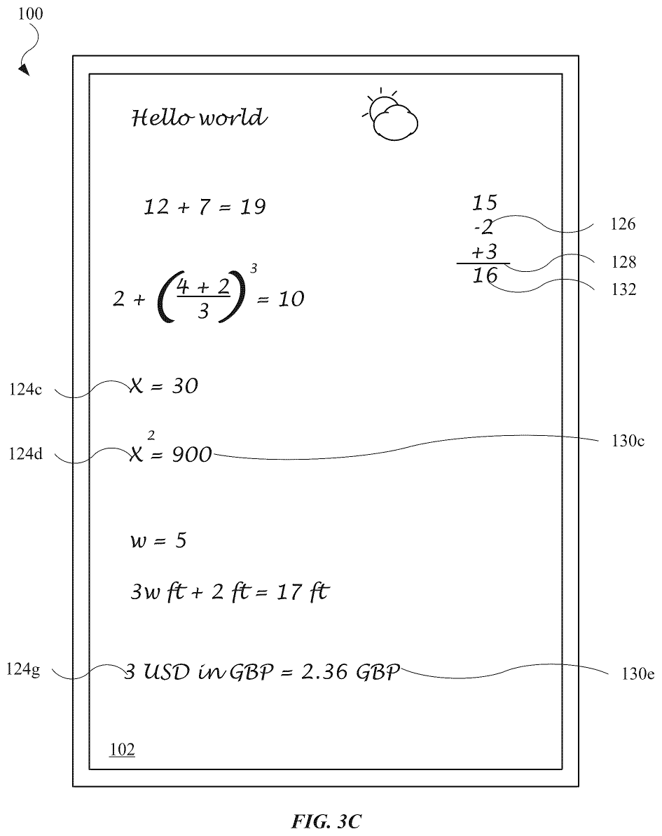

FIG. 3A illustrates a plan view of the electronic device 100, further showing various handwriting strokes presented on the display 102, in accordance with one or more aspects of the present disclosure. As shown, the display 102 is presenting handwriting strokes 120 in the form of text, handwriting strokes 122 in the form of non-text (e.g., a drawing), and several handwriting strokes (discussed below) in the form of math strokes. The display 102 may present the aforementioned handwriting strokes via a handing writing application. Each of the aforementioned handwriting strokes may be written, including manually written, by a user with a user's digit and/or with a digital stylus. The electronic device 100 may include one or more models (e.g., trained ML models, trained LLMs) designed to distinguished the handwriting strokes into text, non-text, and mathematical expressions, even in instances when the handwriting strokes are handwritten. This will be discussed in further detail below.

As shown, the display 102 presents handwriting strokes 124a identified the model(s) as math strokes. In this regard, based the training of the model(s) (and at least some other models described herein), the model(s) may differentiate between handwriting strokes that are math strokes (e.g., handwriting strokes 124a and other similar handwriting strokes shown below) and handwriting strokes that are not handwriting strokes (e.g., handwriting strokes 120, handwriting strokes 122). As shown, the handwriting strokes 124a takes the form of a mathematical expression. The handwriting strokes 124a includes operands (e.g., 12 and 7) and operators (e.g., plus (+) and equal (=) sign).

The display 102 further presents handwriting strokes 124b identified as math strokes. The handwriting strokes 124b may introduce more complex functions, including parenthesis and an exponent (e.g., to the power of 3).

The display 102 further presents handwriting strokes 124c and handwriting strokes 124d, each of which is identified as math strokes. The handwriting strokes 124c may define a variable (e.g., x) in terms of a number (e.g., 20). The handwriting strokes 124d may include a mathematical expression that includes a variable defined in the handwriting strokes 124c. However, the electronic device 100, using one or more models described herein, may group each of the handwriting strokes 124c and 124d together.

The display 102 further presents handwriting strokes 124e and handwriting strokes 124f, each of which is identified as math strokes. The handwriting strokes 124e may define a variable (e.g., w) in terms of a number (e.g., 5). The handwriting strokes 124f may include a mathematical expression that includes not only the variable defined in the handwriting strokes 124e, but also a unit of measure (“ft” representing feet as unit of measure). However, the electronic device 100, using one or more models described herein, may group each of the handwriting strokes 124e and 124f together.

The display 102 further presents handwriting strokes 124g identified as math strokes. The handwriting strokes 124g may include two different currencies (e.g., USD representing the US dollar and EUR representing a Euro). Further, a number (e.g., 2) is positioned proximate to the USD.

In addition to classifying the handwriting strokes 124a, 124b, 124c, 124d, 124e, 124f, and 124g as math strokes, the electronic device 100 may further characterize handwriting strokes 124a, 124b, 124c, 124d, 124e, 124f, and 124g as horizontally oriented math strokes. In this regard, a user has generally written the handwriting strokes 124a, 124b, 124c, 124d, 124e, 124f, and 124g from left to right.

Conversely, however, some handwriting strokes identified as math strokes may be charactered as vertically oriented math strokes. For example, the display 102 further presents handwriting strokes 126 identified as math strokes. As shown, the handwriting strokes 126 includes several numbers (e.g., 15, 2, and 3) generally written by a user from top to bottom. The handwriting stroke 126 may further include operands (e.g., minus (−) signs). Additionally, the handwriting strokes 126 include a handwriting stroke 128. The handwriting stroke 128 may be identified as a non-text handwriting stroke. However, in one or more implementations, the handwriting stroke 128 takes the form of an operator similar to an equal sign.

FIG. 3B illustrates a plan view of the electronic device 100, further showing the display 102 presenting a result (e.g., solution) for handwriting strokes identified as math strokes, in accordance with one or more aspects of the present disclosure. The results may be calculated by one or more operations of the electronic device 100. Moreover, the results, may be calculated in real time by the one or more operations and presented proximate to the handwriting strokes identified as math strokes. Additionally, the electronic device 100 (e.g., one or models thereof) may learn user handwriting strokes in order to present the results with same or similar style (e.g., font style, font dimensions, etc.) as that of the handwriting strokes.

As shown, a result 130a is proximate to the handwriting strokes 124a identified as math strokes. The result 130a may be proximate (e.g., adjacent to, including to the right of) an equal sign of the handwriting strokes 124a. In this regard, the location of the result 130a may represent a solution region of the imagery presented by the display 102. The result 130a (e.g., 19) represents a calculation based on the operands and operators present in the handwriting strokes 124a.

Also, a result 130b is proximate to the handwriting strokes 124b identified as math strokes. The result 130b (e.g., 29) represents a calculation based on the operands and operators present in the handwriting strokes 124b. In this regard, the electronic device 100 is designed to calculate mathematical expressions with exponentials and also follow conventional mathematical rules. For example, the result 130b may be determined by calculating, in mathematical order, parenthesis, exponents, multiplication, division, addition, subtraction (e.g., the PEMDAS rule).

Also, a result 130c is proximate to the handwriting strokes 124d identified as math strokes. The result 130b (e.g., 400) represents a calculation based on the operands and operators present in the handwriting strokes 124c and 124d. In this regard, in one or more implementations, the electronic device 100 is designed to calculate a result of handwriting strokes (e.g., handwriting strokes 124d) using information from other handwriting strokes (e.g., handwriting strokes 124c). For example, the handwriting strokes 124d include a variable (e.g., x) that is defined in the handwriting strokes 124c. Moreover, the electronic device 100 (including one or more models thereof) may determine the handwriting strokes 124c and 124d are linked by a variable (e.g., x), while ignoring other handwriting strokes (e.g., handwriting strokes 124b and handwriting strokes 124e), thus allowing the electronic device 100 (including a calculator application thereof) to correctly determine the result 130c of the mathematical expressions defined by the handwriting strokes 124c and 124d.

Further, a result 130d is proximate to the handwriting strokes 124f identified as math strokes. The result 130d (e.g., 17 ft) represents a calculation based on the operands and operators present in the handwriting strokes 124e and 124f. The electronic device 100 may further determine an implied operator. For example, a number (e.g., 3) is next to a variable (e.g., m). Despite the lack of an operator (e.g., multiplication sign (x or *), the electronic device 100 may determine the user desires a product of the number and the variable. Similar to a prior example, the electronic device 100 is designed to calculate a result of handwriting strokes (e.g., handwriting strokes 124e) using information from other handwriting strokes (e.g., handwriting strokes 124e). Also, the electronic device 100 may apply the same unit of measure (e.g., ft) to the product of the number and variable, thus allowing the result 130d to add together numbers with the same units of measure, thus allowing the result 130d to properly include a unit of measure (e.g., ft) that matches the unit of measure in the handwriting strokes 124f.

Still further, the electronic device 100 may determine context of certain handwriting strokes. For example, the handwriting strokes 124e includes a variable (e.g., m) that is also commonly associated with a unit of measure (e.g., m=meters). The electronic device 100 may determine the variable is not to be associated with a unit of measure. In this example, the handwriting strokes 124e define m=5. Also, the electronic device 100 may determine that based on the grouping of handwriting strokes 124e and 124f, that m is a variable. Alternatively, if a user defined a variable as a unit of measure (e.g., m=meters), the electronic device 100 may determine the presence of mismatched units of measured (e.g., two different units of measure such as meters and feet, or feet and inches) and calculate the result 130d based on a unit conversion that converts one unit of measure to the other unit of measure to provide the result 130d with a common unit of measure.

Still further, a result 130e is proximate to the handwriting strokes 124g identified as math strokes. The result 130d (e.g., 1.85 EUR) represents a calculation based on the operands and operators present in the handwriting strokes 124g. The result 130e represents a conversion of a number of units of one currency (e.g., USD) to another, different currency (e.g., EUR).

Additionally, a result 132 is proximate to (e.g., adjacent to and below) the handwriting strokes 126 identified as math strokes. In this regard, the location of the result 132 may represent a solution region of the imagery presented by the display 102. The result 132 represents a calculation based on the operands and operators present in the handwriting strokes 126. Accordingly, the electronic device 100 may display results differently based on whether the handwriting strokes identified as math strokes are horizontally oriented math strokes or vertically oriented math strokes.

FIG. 3C illustrates a plan view of the electronic device 100, further showing the display 102 presenting updated results based on a change to handwriting strokes identified as math strokes, in accordance with one or more aspects of the present disclosure. As shown, a stroke change (or stroke changes) to at least some of the handwriting strokes are updated by, for example, a user-provided update. For example, the handwriting strokes 124c are updated (e.g., erased or otherwise removed and rewritten) to change the variable x from 20 to 30. The result 130c of the handwriting strokes 124d is re-evaluated and updated from 400 (e.g., the prior result) to 900 (e.g., new result) based on the update to the variable x.

Further, the handwriting strokes 124g are updated to change a number from 2 to 3 and change a currency from EUR to GBP (representing Great British pound or British pound sterling). The result 130e of the handwriting strokes 124g is re-evaluated and updated from 1.85 EUR (e.g., the prior result) to 2.36 GBP (e.g., new result) based on the update to the handwriting strokes 124g.

Still further, the handwriting strokes 126 are updated to change an operator from a minus (−) sign to a plus (+) sign. The result 132 of the handwriting strokes 126 is re-evaluated and updated from 10 (e.g., the prior result) to 16 (e.g., new result) based on the update to the handwriting strokes 126.

The aforementioned updates are exemplary and it should be noted that each of the handwriting strokes shown in FIG. 3C may be updated by a user and correctly re-evaluated by the electronic device 100. Also, although not shown, the electronic device 100 may output a graph result for at least some of the aforementioned handwriting strokes identified as math strokes. The graph result may include a two-dimension plot (e.g., X-Y graph), as a non-limiting example. Also, in one or more implementations, the math strokes include at least one variable. Further, the graph result may be presented at a solution region (e.g., proximate to the math strokes defining a mathematical expression).

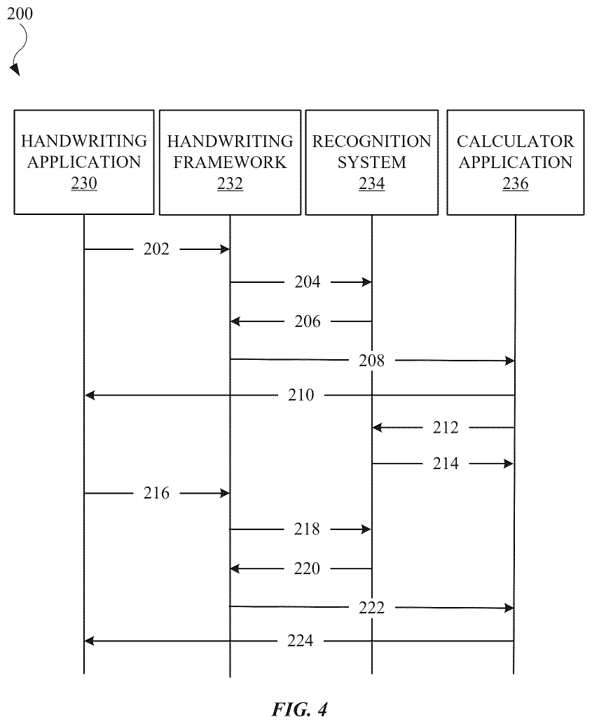

FIG. 4 illustrates an example of a process flow 200 for solving a mathematical expression, in accordance with one or more implementations. The process flow 200 may include a handwriting application 230, a handwriting framework 232, a recognition system 234, and a calculator application 236.

At step 202, the handwriting application 230 provides received inputs to the handwriting framework 232. The handwriting application 230 may include an application used by an electronic device (e.g., electronic device 100 shown in FIG. 1) to receive user inputs at a display (e.g., display 102 shown in FIG. 1). For example, the handwriting application 230 may include a note taking application, a handwriting application, a drawing application, electronic math paper, a word processing application, content editing application, or generally any application that can receive user input. The handwriting framework 232 may analyze the user inputs provided, to the handwriting application 230, to identify handwriting strokes within the user inputs. The handwriting framework 232 may take the form of a system process capable of interacting with any application that allows for handwriting.

At step 204, the handwriting framework 232 provides the identified handwriting strokes to the recognition system 234. In one or more implementations, the recognition system 234 includes one or more models trained to recognize, group, and identify, from the handwriting strokes, text and non-text. Further, the recognition system 234 may be trained to recognize and identify, from the handwriting strokes, math strokes. Several exemplary handwriting strokes identified as math strokes are shown in FIGS. 3A, 3B, and 3C. In this regard, the recognition system 234 may determine whether the handwriting strokes represent one or more math strokes.

The electronic device may include software architecture that includes a handwritten content processing system. The handwritten content processing system includes a stroke input detector, a stroke group selector, a stroke group normalizer, and a handwritten content recognizer. The software architecture includes a handwritten content database which provides storage for stroke data describing input strokes (e.g., including vector representations and metadata of the strokes and including locations of the strokes in a canvas or document), handwritten content data describing words, phrases, etc. detected using the input strokes, and detected data describing actionable data detected using the handwritten content data.

The stroke input detector receives input strokes corresponding to handwritten input from a user. In one or more implementations, the stroke input detector determines, for a given input stroke, the time, location, direction, stroke pressure, and/or stroke force for the input stroke. Stroke pressure as mentioned herein can refer to a measurement of pressure (e.g., force per unit area) of a contact (e.g., a finger contact or a stylus contact) corresponding to a stroke input on a given touch-sensitive surface (e.g., touchscreen, touchpad, etc.). The stroke input detector samples multiple points within a stroke, takes a timestamp for each point sampled in each stroke. Each point within the stroke may include additional data such as location/proximity, stroke pressure, and/or stroke force. In an example, an input stroke can refer to sensor information received starting at stylus down (or an initial touch input) to stylus up (or a touch release), and, for each input stroke, a set of points that are part of each stroke are sampled. The stroke data can be stored in a handwritten content database.

The stroke group selector segments received input strokes into a group that represents a line of text and determines which group new input strokes should be assigned to. For example, the stroke group selector may include a machine-learning engine trained for disambiguation of which strokes in a canvas of handwritten input strokes represent text, and which are not text (e.g., drawings, doodles, artwork, etc.). The machine-learning engine, and/or another machine-learning engine of stroke group selector, may also be trained for segmenting received input strokes into a group that represents a line of text and determining which group new input strokes should be assigned to. Stroke group selector may store, for each stroke, a group identifier and/or a line identifier that identifies which group and/or line the stroke belongs to. The group identifier and/or the line identifier for each stroke may be stored in the stroke data in handwritten content database. Stroke group selector may also store text/non-text labels at the stroke level (e.g., for each stroke) in the stroke data in handwritten content database. Using these text/non-text labels at the stroke level, grouping can be performed to construct lines of text.

The stroke group normalizer normalizes (e.g., straightens, stretches, crops, down-samples or up-samples, etc.) a given group of input strokes such that the group of input strokes can be provided to the handwritten content recognizer as input.

The handwritten content recognizer comprises a machine learning engine that is trained to recognize words, phrases, sentences, paragraphs, and/or other groups of words (e.g., words, phrase, sentences, paragraphs, and/or other groups of words written in Latin script, Chinese characters, Arabic letters, Farsi, Cyrillic, artificial scripts such as emoji characters, etc.) represented by groups of handwritten input strokes, in at least an implementation. In one or more implementations emojis may be treated as non-text. In one or more implementations, the handwritten content recognizer performs text recognition on the strokes of each line of text identified by stroke group selector, to recognize the words, phrases, sentences, paragraphs, and/or other groups of words in the text.

Following this recognition of words, phrases, sentences, paragraphs, and/or other groups of words, the words, phrases, sentences, paragraphs, and/or other groups of words, and/or spatial boundaries of the words, phrases, sentences, paragraphs, and/or other groups of words can be identified in the stroke space by handwritten content recognizer, and stored (e.g., in handwritten content data in a handwritten content database). In this way, the handwritten content data stored in handwritten content database can facilitate identification of multiple granularities of groups of text (e.g., words, phrases, sentences, lines, paragraphs, etc.), such as for lasso-less selection of the handwritten input text and/or for data detection on the handwritten input text. In some implementations, text and/or groups of strokes can also be selected using a “lasso” operation in which a stylus, touch input, or the like is used to draw a “lasso” around the strokes to select the strokes. However, this can be a time-consuming and/or non-intuitive mode of selection for text. In a lasso-less selection, the text can be selected by tapping or swiping/brushing over the text itself, rather than drawing a lasso around the text.

The software architecture may also include a data detector. Data detector may operate on handwritten content data (e.g., words, phrases, sentences, paragraphs, and/or other groups of words) generated by handwritten content recognizer to detect actionable data in the handwritten content data. Actionable data may include telephone numbers, flight numbers, physical addresses, email addresses, uniform resource locators (URI)'s.

Handwritten content data may include, for example, files, documents, images, etc., with handwritten content and/or associated metadata for the handwritten content. Such metadata can include information for rendering the handwritten content for display on the electronic device 100. The software architecture includes an indexer that indexes the handwritten content data with associated input stroke data and stores index data for performing searches on the handwritten content and the associated input stroke data into the handwritten content index. The software architecture further includes a system search component that enables searches to be performed, on a system-wide or device-wide level, on the handwritten content data by using the handwritten content index.

Further, although recognition of handwritten content is described above, implementations of the subject technology are capable of distinguishing between handwritten content corresponding to text characters and handwritten content that corresponds to, for example, doodles or artwork (e.g., non-textual information).

Implementations of the subject technology provide techniques for assigning an input stroke to a stroke group (e.g., a group of input strokes corresponding to a line of handwritten text). No assumption about line writing direction, straightness or scale is made by the techniques described herein. The subject technology is advantageously enabled to follow and normalize a sequence of handwritten printed or cursive characters along any continuous curve: straight line, wavy lines, lines with sharp angles, spirals, squared spirals, etc. The subject technology is agnostic to the script (Latin alphabet, Chinese characters, Arabic, etc.) present in the handwritten content, and can handle any patterns that exhibit the characteristics of handwritten text without assuming or being reliant upon more regularity in the text lines (e.g., horizontality of the writing, enforcing of writing direction, straightness of the text lines, no invariance in character orientation, strict regularity in the size of characters, etc.).

Additionally, the handwritten content recognizer may utilize a ranking algorithm for top n number of likely words. The top candidate words can be stored in a handwritten content index, such as for later use in searches, text selections, copy/paste operations and/or data detection.

Stroke data may include, for each of one or more active handwritten input canvases (e.g., in a user interface for a handwritten input application such as a notes application, a word processor application, a messaging application, a graphics application, etc.) and/or for each of one or more stored documents, a set of strokes, and stroke information (e.g., a stroke identifier, a start location, an end location, mathematical curve information, rendering metadata, a group identifier identifying a group or a line that the stroke belongs to, a word identifier identifying the word that the stroke belongs to, etc.) for each stroke. Handwritten content data may include words, phrases, sentences, paragraphs, characters, etc. that have been identified (e.g., in each line) as being represented by the strokes for each active handwritten input canvas or stored document. Detected data may include, for example, actionable data detected in the handwritten content data, such as phone numbers, flight numbers, physical addresses, uniform resource locators (URLs), names or other identifiers of stored contacts. Handwritten content index may include indexed information for efficiently identifying stroke data and/or detected data that is associated with words, phrases, etc. in the handwritten content data

The one or more models may be trained using training data with several mathematical expressions similar to those in FIGS. 3A, 3B, and 3C. Further, the one or more models undergo supervised training using various tagged training data with operators and operands identified for the one or more models. This may further include training data used to train the one or more models on shapes (e.g., lines, curves, etc.) associated with math strokes. Accordingly, the recognition system 234 may include shape detection capabilities designed to determine the present of math strokes based on the shape(s) of the handwriting strokes. Moreover, the recognition system 234 may be trained to group together multiple mathematical expressions (e.g., handwriting strokes 124c and 124d identified as math strokes) such that a result (e.g., solution) is produced from at least one of the mathematical expressions. As a result, the recognition system 234 may not only identify math strokes, but also group math strokes together to form mathematical expressions.

Moreover, the training data may include data identified and/or classified as horizontally oriented math strokes as well as data identified and/or classified as vertically oriented math strokes. In this regard, the recognition system 234 may separate sub-classes of identified math strokes into sub-classes corresponding to horizontally oriented math strokes or vertically oriented math strokes. At least one indication of horizontally oriented math strokes may include an equal sign, while at least one indication of vertically oriented math strokes may include a line (e.g., handwriting stroke 128 shown in FIG. 3A).

The handwriting strokes identified as math strokes may be tagged with data (e.g., as metadata) to allow other systems to recognize the strokes as math strokes.

At step 206, the recognition system 234 provides the identified math strokes, including the tagged data, to the handwriting framework 232. The handwriting framework 232 may store the identified math strokes in a state. For example, the host may store the identified math strokes in a persistent state. This allows the handwriting framework 232 to recognize each mathematical expression, including an assigned number to a variable.

In addition to grouping math strokes together to form mathematical expressions, the recognition system 234 may synthesize the mathematical expressions and send the synthesized mathematical expressions to the handwriting framework 232. In this regard, the recognition system 234 facilitate the handwriting framework 232 in obtaining information regard each mathematical expression presented on a display (e.g., a display 102 shown in FIGS. 3B and 3C). Thus, the handwriting framework 232 may determine each of the variables and units of measures, as non-limiting examples, of each mathematical expression presented on a display. Beneficially, the overall processing time is minimized. The recognition system 234 may generate a structured document and/or data structure (e.g., using LaTeX) that includes describes each of the mathematical expressions. The structured document and/or data structure is then provided to the calculator application 236 for processing.

At step 208, the handwriting framework 232 provides the mathematical expressions, based on the identified math strokes, to the calculator application 236. The calculator application 236 may communicate with one or more of the handwriting application 230, the handwriting framework 232, or the recognition system 234 via a math API. The calculator application 236 may solve the mathematical expressions and generate one or more results (e.g., results shown in FIG. 3B). In one or more implementations, a mathematical evaluation request, or simply a math request, is generated, thus providing an indication that a result is desired from at least some of the mathematical expressions.

A trigger for math request may be generated in several ways. For example, the math request may be implied by, for example, an equal sign for horizontally oriented mathematical expressions (defined by horizontally oriented math strokes) or a horizontal line for vertically oriented mathematical expressions (defined by vertically oriented math strokes). Accordingly, the handwriting framework 232 may be aware of the math request based a portion of the math strokes, and the calculator application 236 may automatically generate a result. Alternatively, in one or more implementation, the recognition system 234 receives the math request from the handwriting framework 232. For example, a user may define a particular time to generate the result. This may allow for a pause for the user to determine the result by his or her own cognitive skills. Also, at step 208, the handwriting framework 232 may also provide its current state to the calculator application 236.

At step 210, the result(s) generated by the calculator application 236 are provided to the handwriting application 230. The handwriting application 230 may update the images representing the math strokes by presenting the respective results proximate to the math strokes, thus allowing a user to review the results (e.g., as shown in FIG. 3B). In or more implementations, the result generated by the calculator application 236 is a result of a horizontally or vertically oriented mathematical expression. Alternatively, in or more implementations, the result generated by the calculator application 236 is a graph result. In one or more implementations, the graph result is sent directly to the handing application 230 without sending it to the handwriting framework 232.

The process flow 200 may also include optional steps. For example, at step 212, the calculator application 236 may communicate an error to the recognition system 234. This may occur when the calculator application 236 identifies an error, a discrepancy, or other issue with the math strokes (including math strokes grouped together) that prevents the calculator application 236 from generating the result. For example, the letter x may be commonly used as a variable or as a multiplication operator. In one or more implementations, to determine a vertically oriented mathematical expression, one or more models may be trained to identify non-text handwriting strokes such as a line (e.g., horizontal line) and a number proximate to the line. The identified number may represent the bottom, or “last”, number of a series of numbers in a vertically oriented mathematical expression. The one or more models may further be trained to identify and group any number or numbers above the bottom line as being part of the same vertically oriented mathematical expression. Also, one or more models may further be trained to determine a number is the top, or “first”, number of the vertically oriented mathematical expression when no other numbers are above the top number. Each number in a vertically oriented mathematical expression may form a stroke grouping. The aforementioned examples of the calculator application 236 illustrates the calculator application 236 (and in some cases, the recognition system 234) may determine a semantic understanding of mathematical expressions and one or more particular relationships between math strokes.

Additionally, an error may occur at the calculator application 236 may while attempting to generate a result. The recognition system 234 may evaluate and correct the grouping error.

At step 214, the recognition system 234 returns data to the calculator application 236 to correct the error(s) identified by the calculator application 236.

Additionally, at step 216, the handwriting application 230 provides updated user inputs to the handwriting framework 232. The updated user inputs may include handwriting strokes associated with a change to a variable, an operator, a unit of measure, or a currency, as non-limiting examples. The handwriting framework 232 may identify handwriting strokes associated with math strokes. At step 218, the handwriting framework 232 provides the identified (updated) handwriting strokes to the recognition system 234, where the recognition system 234 analyzes the identified handwriting strokes for math strokes and tags the identified handwriting strokes with data. At step 220, the recognition system 234 provides the identified (updated) math strokes, including the tagged data, to the handwriting framework 232, where the handwriting framework 232 stores the identified math strokes in an updated state. At step 222, the handwriting framework 232 provides the mathematical expressions, based on the identified (updated) math strokes, to the calculator application 236 for the calculator application 236 to re-evaluate the updated mathematical expressions and generates an updated result (e.g., updated solution). Also, at step 222, the handwriting framework 232 may also provide its updated state to the calculator application 236. At step 224, the updated result(s) generated by the calculator application 236 are provided to the handwriting application 230. The handwriting application 230 may update the image with the new results (e.g., as shown in FIG. 3C). This may include, in some cases, an updated graph result.

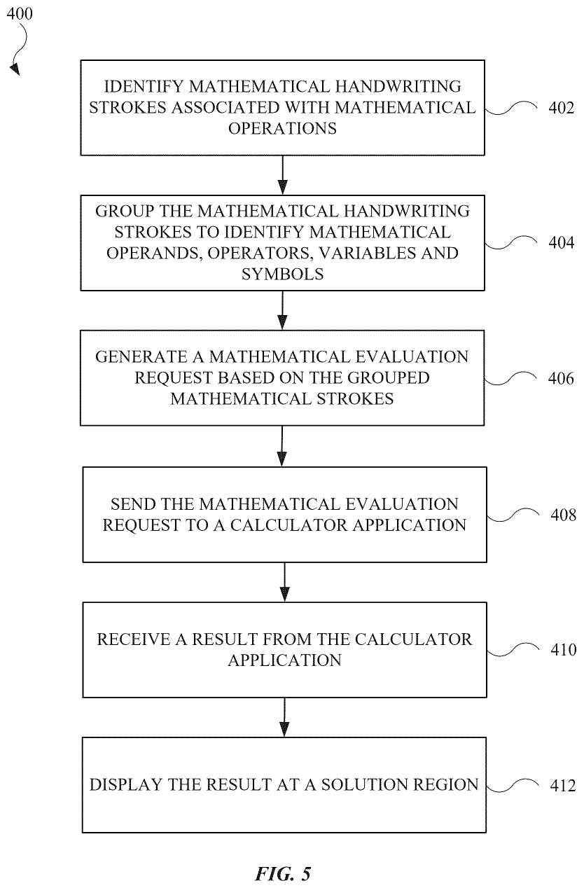

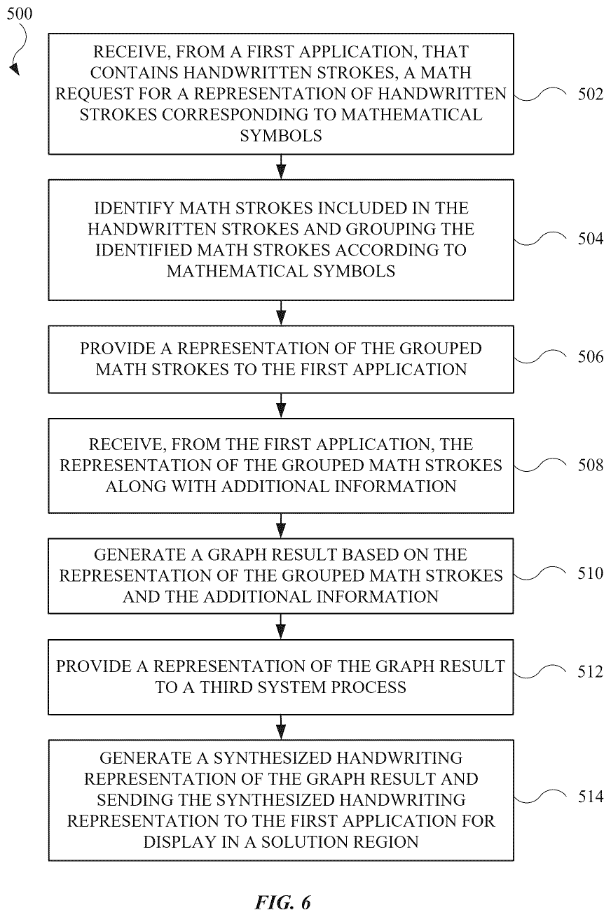

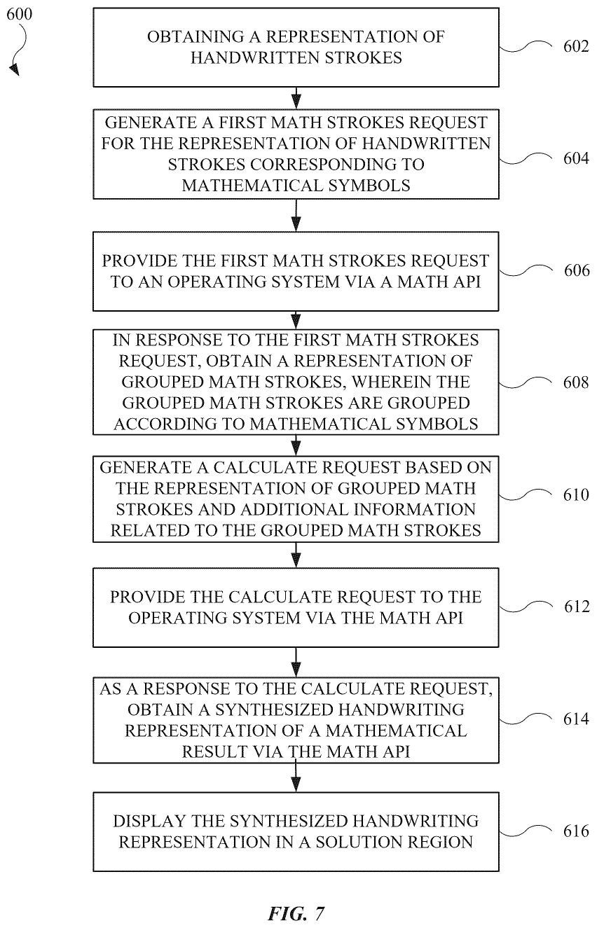

FIG. 5, FIG. 6, and FIG. 7 illustrate flow diagrams showing examples of processes that may be performed for determining a result to a mathematical expression generated by handwriting strokes, in accordance with one or more aspects of the present disclosure. An electronic device (e.g., electronic device 100 shown in FIG. 1) may be used in part to conduct one or more steps of the example processes. For explanatory purposes, the respective processes shown in FIGS. 6-8 are primarily described herein with reference to the electronic device 100, which may include a smartphone or a tablet computing device. However, the respective processes shown in FIGS. 6-8 are not limited to the electronic device 100, and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 5 illustrates a flow diagram showing an example of a process 400 that may be performed for determining a result to a mathematical expression generated by handwriting strokes, in accordance with one or more aspects of the present disclosure.

At block 402, mathematical handwriting strokes associated with mathematical operations are identified. The process 400 may rely on a transformer, one or more models, a detector (e.g., shape detector).

At block 404, the mathematical handwriting strokes are grouped to identify mathematical operands, operators, variables and symbols. This may include the identification of numbers, variables (including variables with any detected mathematical strokes detected on a display of an electronic device).

At block 406, a mathematical evaluation request is generated request based on the grouped mathematical strokes. The mathematical evaluation request may be an implied request by, for example, detection of an equal sign (for horizontally oriented mathematical expressions) or detection of a non-text hands stroke (for vertically oriented mathematical expressions). For these exemplary indicators corresponding to an implied request, the process 400 may subsequently return a result (e.g., solution) automatically without an express user request. Alternatively, a user may generate a request to provide a result.

At block 408, the mathematical evaluation request is sent to a calculator application. The calculator application may receive one or more mathematical expressions in which the calculator can solve.

At block 410, a result is received from the calculator application. The result may include a solution to the one or more mathematical expressions.

At block 412, displaying the result is displayed at a solution region. The result may display proximate to an equal sign (for horizontally oriented mathematical expressions) or proximate to a non-text hands stroke (for vertically oriented mathematical expressions), which may include below a stack of numbers and/or variables.

FIG. 6 illustrates a flow diagram showing an alternate example of a process 500 that may be performed for determining a result to a mathematical expression generated by handwriting strokes, in accordance with one or more aspects of the present disclosure.

At block 502, at a first system process (e.g., handwriting framework 232) of a device, a math request for a representation of the handwriting strokes corresponding to mathematical symbols is received. The math request may be received form a first application that includes handwriting strokes (e.g., variables, symbols, operands, operators, etc.). The math request may include at least a portion the handwriting strokes.

At block 504, at the first system process, in response to receiving the math request, math strokes included in the handwriting strokes are identified and the identified math strokes (e.g., using a transformer model, etc.) are grouped according to mathematical symbols (e.g. variables, operands, operators, notational symbols, etc.).

At block 506, a representation of the grouped math strokes is provided to the first application.

At block 508, at a second system process (e.g., calculator application 236) (e.g., an LLM, a calculator, etc.) of the device, the representation of the grouped math strokes along with additional information (e.g., variable values related to the math strokes, etc.) is received from the first application.

At block 510, at the second system process, a graph result based on the representation of the grouped math strokes and the additional information is generated.

At block 512, at the second system process, a representation of the graph result is provided to a third system process (e.g., handwriting framework 232).

At block 514, at the third system process, generating a synthesized handwriting representation of the graph result is generated and the synthesized handwriting representation is sent to the first application for display in a solution region (e.g., next to the equation, superimposed over the equation, as a replacement to the equation, where selecting the graph allows the user to edit the equation, etc.).

FIG. 7 illustrates a flow diagram showing an alternate example of a process 600 that may be performed for determining a result to a mathematical expression generated by handwriting strokes, in accordance with one or more aspects of the present disclosure.

At block 602, a representation of handwriting strokes is obtained (e.g., a set of one or more handwritten text strokes, non-text strokes, mathematical strokes). The representation may be obtained by the handwriting framework 232.

At block 604, a first math strokes request for the representation of handwriting strokes corresponding to mathematical symbols (e.g., variables, symbols, operands, operators, etc.) is generated. The math strokes request may include at least a portion the handwriting strokes. As an example, the math request is received from software corresponding to the first application and/or a framework (e.g., a software framework) that is used by the first application. The framework is loaded in a process space of the first application. The first application is different from the system process. In some embodiments, the first application is executing on the device. The first application is executing on another device different from the device).

At block 606, providing the first math strokes request are provided to an operating system via a math API.

At block 608, in response to the first math strokes request, obtaining a representation of grouped math strokes is obtained. The grouped math strokes are grouped according to mathematical symbols (e.g. variables, operands, operators, notational symbols, etc.).

At block 610, generating a calculate request is generated. The calculate request may be based on the representation of grouped math strokes and additional information related to the grouped math strokes.

At block 612, the calculate request is provided to the operating system via the math API.

At block 614, as a response to the calculate request, a synthesized handwriting representation of a mathematical result via the math API is obtained. In some embodiments, the synthesized handwriting representation is a default synthesized representation of the mathematical result that is not personalized to a user corresponding to the handwriting input. In some embodiments, the synthesized representation is personalized to the user. In some implementations, the synthesized handwriting obtained via the math API for a first set of mathematical results is the default representation, however, as additional mathematical results are generated over time, the synthesized handwriting obtained for those results is personalized to the user. Over time, the personalization increases as the system further learns the user's handwriting.

At block 616, displaying the synthesized handwriting representation is displayed in a solution region (e.g., to the right of an “equals” symbol, or under the bottom line of a vertical equation).

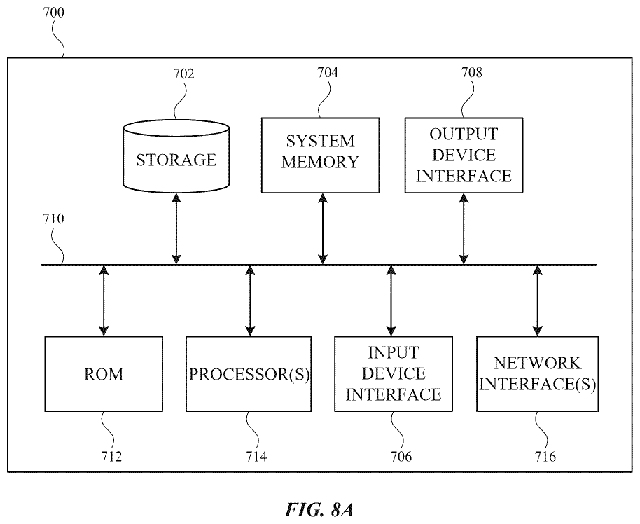

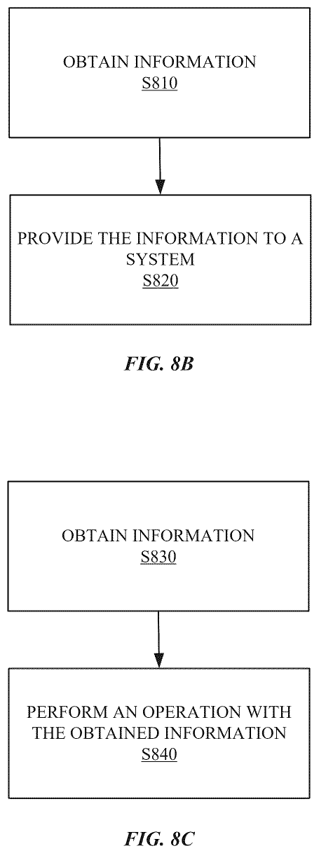

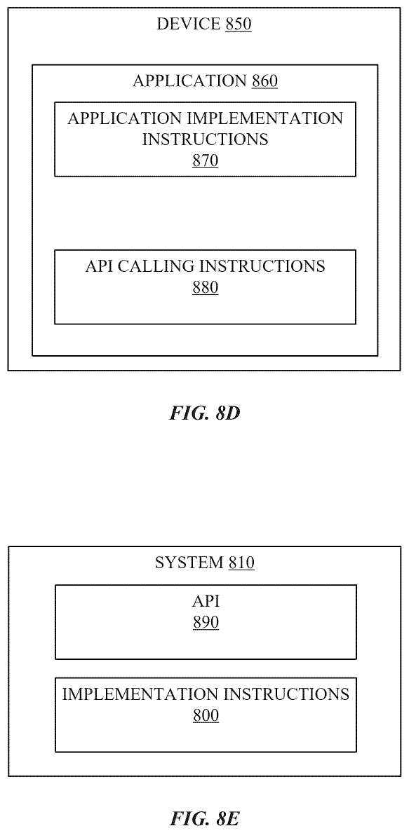

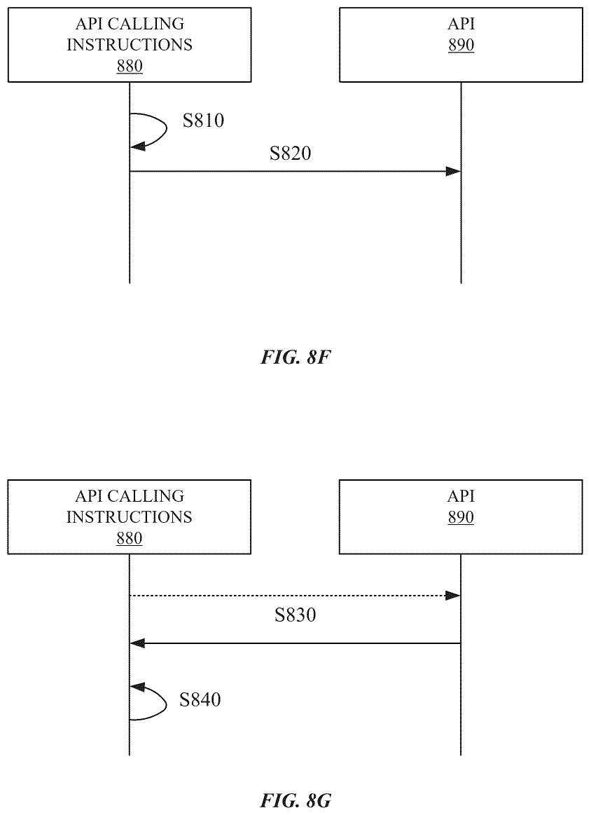

FIG. 8A illustrates an electronic system 700 with which one or more implementations of the subject technology may be implemented. The electronic system 700 can be, and/or can be a part of, the electronic device 100 as shown in FIG. 1. The electronic system 700 may include various types of computer readable media and interfaces for various other types of computer readable media. The electronic system 700 includes a bus 710, one or more processing units 714, a system memory 704 (and/or buffer), a ROM 712, a permanent storage device 702, an input device interface 706, an output device interface 708, and one or more network interfaces 716, or subsets and variations thereof.

The bus 710 collectively represents all system, peripheral, and chipset buses that communicatively connect the numerous internal devices of the electronic system 700. In one or more implementations, the bus 710 communicatively connects the one or more processing units 714 with the ROM 712, the system memory 704, and the permanent storage device 702. From these various memory units, the one or more processing units 714 retrieves instructions to execute and data to process in order to execute the processes of the subject disclosure. The one or more processing units 714 can be a single processor or a multi-core processor in different implementations.

The ROM 712 stores static data and instructions that are needed by the one or more processing units 714 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing units 714 may need at runtime. In one or more implementations, the processes of the subject disclosure are stored in the system memory 704, the permanent storage device 702, and/or the ROM 712 (which are each implemented as a non-transitory computer-readable medium). From these various memory units, the one or more processing units 714 retrieves instructions to execute and data to process in order to execute the processes of one or more implementations.

The bus 710 also connects to the input device interface 706 and output device interface 708. The input device interface 706 enables a user to communicate information and select commands to the electronic system 700. Input devices that may be used with the input device interface 706 may include, for example, alphanumeric keyboards and pointing devices (also called “cursor control devices”). The input device interface 706 may enable, for example, the display of images generated by electronic system 700. Output devices that may be used with the input device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, the bus 710 also couples the electronic system 700 to one or more networks and/or to one or more network nodes, such as the electronic devices 72 and 74 shown in FIG. 1, through the one or more network interfaces 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

FIG. 8B, FIG. 8C, FIG. 8D, FIG. 8E, FIG. 8F, and FIG. 8G illustrate processes executable by electronic devices or block diagrams of electronic devices with which one or more implementations of the subject technology may be implemented. Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

Implementations within the scope of the present disclosure include a computer-readable storage medium that encodes instructions organized as an application (e.g., application 860) that, when executed by one or more processing units, control an electronic device (e.g., a device 850) to perform the method of FIG. 8B, the method of FIG. 8C, and/or one or more other processes and/or methods described herein.

It should be recognized that application 860 (shown in FIG. 8D) can be any suitable type of application, including, for example, one or more of: a notes application, a browser application, an application that functions as an execution environment for plug-ins, widgets or other applications, a fitness application, a health application, a digital payments application, a media application, a social network application, a messaging application, and/or a maps application. In some embodiments, application 860 is an application that is pre-installed on the device 850 at purchase (e.g., a first party application). In other embodiments, application 860 is an application that is provided to the device 850 via an operating system update file (e.g., a first party application or a second party application). In other embodiments, application 860 is an application that is provided via an application store. In some embodiments, the application store can be an application store that is pre-installed on the device 850 at purchase (e.g., a first party application store). In other embodiments, the application store is a third-party application store (e.g., an application store that is provided by another application store, downloaded via a network, and/or read from a storage device).

Referring to FIG. 8B and FIG. 8F, application 860 obtains information (e.g., S810). In some embodiments, at S810, information is obtained from at least one hardware component of the device 850. In some embodiments, at S810, information is obtained from at least one software module (e.g., set of instructions) of the device 850. In some embodiments, at S810, information is obtained from at least one hardware component external to the device 850 (e.g., a peripheral device, an accessory device, a server, etc.). In some embodiments, the information obtained at S810 includes positional information, time information, notification information, user information, environment information, electronic device state information, weather information, media information, historical information, event information, hardware information, and/or motion information. In some embodiments, in response to and/or after obtaining the information at S810, application 860 provides the information to a system (e.g., S820).

In some embodiments, the system (e.g., 810 shown in FIG. 8E) is an operating system hosted on the device 850. In some embodiments, the system (e.g., 810 shown in FIG. 8E) is an external device (e.g., a server, a peripheral device, an accessory, a personal computing device, etc.) that includes an operating system.

Referring to FIG. 8C and FIG. 8G, application 860 obtains information (e.g., S830). In some embodiments, the information obtained at S830 includes positional information, time information, notification information, user information, environment information electronic device state information, weather information, media information, historical information, event information, hardware information and/or motion information. In response to and/or after obtaining the information at S830, application 860 performs an operation with the information (e.g., S840). In some embodiments, the operation performed at S840 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 810 based on the information.

In some embodiments, one or more steps of the method of FIG. 8B and/or the method of FIG. 8C is performed in response to a trigger. In some embodiments, the trigger includes detection of an event, a notification received from system 810, a user input, and/or a response to a call to an API provided by system 810.

In some embodiments, the instructions of application 860, when executed, control device 850 to perform the method of FIG. 8B and/or the method of FIG. 8C by calling an application programming interface (API) (e.g., API 890) provided by system 810. In some embodiments, application 860 performs at least a portion of the method of FIG. 8B and/or the method of FIG. 8C without calling API 890.

In some embodiments, one or more steps of the method of FIG. 8B and/or the method of FIG. 8C includes calling an API (e.g., API 890) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8D, device 850 is illustrated. In some embodiments, device 850 is a personal computing device, a smart phone, a smart watch, a fitness tracker, a head mounted display (HMD) device, a media device, a communal device, a speaker, a television, and/or a tablet. Device 850 includes application 860 and an operating system (not shown) (e.g., system 810 shown in FIG. 8E). Application 860 includes application implementation instructions 870 and API calling instructions 880. System 810 includes API 890 and implementation instructions 800. It should be recognized that device 850, application 860, and/or system 810 can include more, fewer, and/or different components than illustrated in FIG. 8D and 8E.

In some embodiments, application implementation instructions 870 is a software module that includes a set of one or more computer-executable instructions. In some embodiments, the set of one or more instructions of the application implementation instructions 870 correspond to one or more operations performed by application 860. For example, when application 860 is a messaging application, the application implementation instructions 870 can include operations to receive and send messages. In some embodiments, the application implementation instructions 870 communicates with API calling instructions to communicate with system 810 via API 890 (shown in FIG. 8E).

In some embodiments, API calling instructions 880 is a software module that includes a set of one or more computer-executable instructions.

In some embodiments, implementation instructions 800 is a software module that includes a set of one or more computer-executable instructions.

In some embodiments, API 890 is a software module that includes a set of one or more computer-executable instructions. In some embodiments, API 890 provides an interface that allows a different set of instructions (e.g., API calling instructions 880) to access and/or use one or more functions, methods, procedures, data structures, classes, and/or other services provided by implementation instructions 800 of system 810. For example, API calling instructions 880 can access a feature of implementation instructions 800 through one or more API calls or invocations (e.g., embodied by a function or a method call) exposed by API 890 and can pass data and/or control information using one or more parameters via the API calls or invocations. In some embodiments, API 890 allows application 860 to use a service provided by a Software Development Kit (SDK) library. In other embodiments, application 860 incorporates a call to a function or method provided by the SDK library and provided by API 890 or uses data types or objects defined in the SDK library and provided by API 890. In some embodiments, API calling instructions 880 makes an API call via API 890 to access and use a feature of implementation instructions 800 that is specified by API 890. In such embodiments, implementation instructions 800 can return a value via API 890 to API calling instructions 880 in response to the API call. The value can report to application 860 the capabilities or state of a hardware component of device 850, including those related to aspects such as input capabilities and state, output capabilities and state, processing capability, power state, storage capacity and state, and/or communications capability. In some embodiments, API 890 is implemented in part by firmware, microcode, or other low level logic that executes in part on the hardware component.

In some embodiments, API 890 allows a developer of API-calling instructions 880 (which can be a third-party developer) to leverage a feature provided by implementation instructions 800. In such embodiments, there can be one or more set of API-calling instructions (e.g., including API-calling instructions 880) that communicate with implementation instructions 800. In some embodiments, API 890 allows multiple sets of API-calling instructions written in different programming languages to communicate with implementation instructions 800 (e.g., API 890 can include features for translating calls and returns between implementation instructions 800 and API-calling instructions 880) while API 890 is implemented in terms of a specific programming language. In some embodiments, API-calling instructions 880 calls APIs from different providers such as a set of APIs from an OS provider, another set of APIs from a plug-in provider, and/or another set of APIs from another provider (e.g., the provider of a software library) or creator of the another set of APIs.

Examples of API 890 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 850. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 800 is a system (e.g., operating system, server system) software module (e.g., a collection of computer-readable instructions) that is constructed to perform an operation in response to receiving an API call via API 890. In some embodiments, implementation instructions 800 is constructed to provide an API response (via API 890) as a result of processing an API call. By way of example, implementation instructions 800 and API-calling instructions 880 can each be any one of an operating system, a library, a device driver, an API, an application program, or other module. It should be understood that implementation instructions 800 and API-calling instructions 880 can be the same or different type of software module from each other. In some embodiments, implementation instructions 800 is embodied at least in part in firmware, microcode, or other hardware logic.

In some embodiments, implementation instructions 800 returns a value through API 890 in response to an API call from API-calling instructions 880. While API 890 defines the syntax and result of an API call (e.g., how to invoke the API call and what the API call does), API 890 might not reveal how implementation instructions 800 accomplishes the function specified by the API call. Various API calls are transferred via the one or more application programming interfaces between API-calling instructions 880 and implementation instructions 800. Transferring the API calls can include issuing, initiating, invoking, calling, receiving, returning, and/or responding to the function calls or messages. In other words, transferring can describe actions by either of API-calling instructions 880 or implementation instructions 800. In some embodiments, a function call or other invocation of API 890 sends and/or receives one or more parameters through a parameter list or other structure.

In some embodiments, implementation instructions 800 provides more than one API, each providing a different view of or with different aspects of functionality implemented by implementation instructions 800. For example, one API of implementation instructions 800 can provide a first set of functions and can be exposed to third party developers, and another API of implementation instructions 800 can be hidden (e.g., not exposed) and provide a subset of the first set of functions and also provide another set of functions, such as testing or debugging functions which are not in the first set of functions. In some embodiments, implementation instructions 800 calls one or more other components via an underlying API and thus be both an set of API calling instructions and a set of implementation instructions. It should be recognized that implementation instructions 800 can include additional functions, methods, classes, data structures, and/or other features that are not specified through API 890 and are not available to API calling instructions 880. It should also be recognized that API calling instructions 880 can be on the same system as implementation instructions 800 or can be located remotely and access implementation instructions 800 using API 890 over a network. In some embodiments, implementation instructions 800, API 890, and/or API-calling instructions 880 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD−RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

As described above, one aspect of the present technology is the gathering and use of data available from specific and legitimate sources for receiving handwriting strokes and providing a result (e.g., solution to a mathematical expression) based on the received handwriting strokes. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for receiving handwriting strokes and providing a result (e.g., solution to a mathematical expression) based on the received handwriting strokes.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of receiving handwriting strokes and providing a result (e.g., solution to a mathematical expression) based on the received handwriting strokes, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
identifying mathematical handwriting strokes associated with mathematical operations;
grouping the mathematical handwriting strokes to identify one or more mathematical operands, operators, variables or symbols;
generating a mathematical evaluation request based on the grouped mathematical strokes;
sending the mathematical evaluation request to a calculator application;
receiving a result from the calculator application; and
displaying the result at a solution region that is proximate to at least some of the identified mathematical handwriting strokes.

2. The method of claim 1, wherein identifying the mathematical handwriting strokes comprises identifying handwriting strokes at a display of an electronic device.

3. The method of claim 1, further comprising subsequent to displaying the result:
identifying second mathematical strokes;
updating, based on the identified second mathematical strokes, the result; and
displaying the updated result at the solution region.

4. The method of claim 1, further comprising determining whether the grouped mathematical strokes comprise a horizontally oriented mathematical expression or a vertically oriented mathematical expression.

5. The method of claim 4, in response to determining whether the grouped mathematical strokes comprise the vertically oriented mathematical expression identifying a non-text handwriting stroke.

6. The method of claim 4, in response to determining whether the grouped mathematical strokes comprise the horizontally oriented mathematical expression, identifying an equal sign within the horizontally oriented mathematical expression, wherein the solution region is proximate to the equal sign.

7. The method of claim 1, wherein the calculator application is configured to:
determine an error in the grouped mathematical strokes; and
provide the error to a recognition system for evaluation of the error.

8. The method of claim 1, wherein identifying mathematical strokes comprises identifying a shape of the mathematical strokes.

9. A method, comprising:
at a first system process of a device:
receiving, from a first application that comprises handwritten strokes, a math request for a representation of handwritten strokes corresponding to mathematical symbols, wherein the math request includes at least a portion the handwritten strokes;
in response to receiving the math request:
identifying math strokes included in the handwritten strokes included in the math request and grouping the identified math strokes according to mathematical symbols; and
providing a representation of the grouped math strokes to the first application;
at a second system process of the device:
receiving, from the first application, the representation of the grouped math strokes along with additional information;
generating a graph result based on the representation of the grouped math strokes and the additional information; and
providing a representation of the graph result to a third system process of the device; and
at the third system process:
generating a synthesized handwriting representation of the graph result and sending the synthesized handwriting representation to the first application for display in a solution region.

10. The method of claim 9, wherein the first application comprises a handwriting application configured to receive handwriting strokes from a user.

11. The method of claim 9, wherein the second system process is configured to:
determine an error in the grouped math strokes; and
provide the error to the first system process for evaluation of the error.

12. The method of claim 9, further comprising:
receiving, at the second system process, an update to one or more of the representation of the grouped math strokes along with additional information; and
generating, based on the update, an updated graph result.

13. The method of claim 9, wherein the second system process comprises one or more of a calculator application or a recognition system.

14. The method of claim 9, wherein the representation of the math strokes comprises a mathematical expression, and the graph result is based on the mathematical expression.

15. The method of claim 9, wherein the math request comprises an equal sign or a non-text handwriting stroke.

16. A non-transitory computer readable medium storing instructions of an application for controlling an electronic device to perform a method, the method comprising:
obtaining a representation of handwritten strokes;
generating a first math strokes request for the representation of handwritten strokes corresponding to mathematical symbols (e.g., variables, symbols, operands, operators, etc.), wherein the first math strokes request includes at least a portion the handwritten strokes;
providing the first math strokes request to an operating system via a math application program interface (API);
in response to the first math strokes request, obtaining a representation of grouped math strokes, wherein the grouped math strokes are grouped according to mathematical symbols;
generating a calculate request based on the representation of grouped math strokes and additional information related to the grouped math strokes;
providing the calculate request to the operating system via the math API;
as a response to the calculate request, obtaining a synthesized handwriting representation of a mathematical result via the math API; and
displaying the synthesized handwriting representation in a solution region.

17. The non-transitory computer readable medium of claim 16, wherein in response to detecting a stroke change defining updated strokes, the application sends a second math strokes request to the operating system, using the updated strokes, and in response to the updated strokes resulting in an updated mathematical result, the application receives and displays the synthesized handwriting representation of an updated mathematical result.

18. The non-transitory computer readable medium of claim 16, wherein:
the math strokes identify units of measure, and
the synthesized handwriting representation of the mathematical result comprises the units of measure.

19. The non-transitory computer readable medium of claim 16, wherein:
math strokes in the first math strokes request identify units of measure, and
the synthesized handwriting representation of the mathematical result is generated by performing unit conversion for mismatched units.

20. The non-transitory computer readable medium of claim 16, further comprising storing the representation of grouped math strokes to generate a semantic understanding of the grouped math strokes and a relationship between the math strokes.
